(19) United States
(12) Patent Application Publication
(10) Pub. No.: US 2026/0296322 A1
(43) Pub. Date: Oct. 1, 2026

(54) MODULAR TRAY CONSOLE FOR A VEHICLE

(71) Applicant: Honda Motor Co., Ltd., Tokyo (JP)

(72) Inventors: Brendan Christopher STIVER, Cable, OH (US); Dwayne W. MALONE, Plain City, OH (US); James J. YANG, Dublin, OH (US); Sarah BOYLAN, Columbus, OH (US)

(21) Appl. No.: 19/095,324

(22) Filed: Mar. 31, 2025

(51) Int. Cl. B60R 7/04

(52) U.S. Cl. CPC B60R 7/04

(57) ABSTRACT

A modular tray console for a vehicle includes a center console including a body defining an interior compartment, and a bin removably received in the interior compartment. The bin defines a bin compartment and has a mounting portion. At least one tray is removably mounted to the body of the center console. The bin has a first position where the mounting portion is located in the interior compartment of the center console and the bin compartment is accessible from outside the center console. The bin has a second position where the mounting portion is removed from the interior compartment and the at least one tray is connectable to the mounting portion to define a support surface.

### BACKGROUND

Vehicle owners are increasingly utilizing their vehicles in a number of ways that do not involve driving. Many vehicle owners state that they use their vehicles to relax, for privacy, and as a place to work, all while not driving, although the vehicle may be driven to various locations for these additional activities. In connection with these activities, vehicle users may desire a surface to eat from, a desk on which to use electronic devices and a table to organize camping gear, cameras, beverages, and the like. The use of a table surface in stationary moments can be beneficial in daily vehicle use and may be even more beneficial in off-road journeys, such as camping. In this respect, users may desire a table that can be used in a number of non-driving situations in connection with a vehicle.

### BRIEF DESCRIPTION

According to one aspect, a modular tray console for a vehicle comprises a center console including a body defining an interior compartment, and a bin removably received in the interior compartment. The bin defines a bin compartment and has a mounting portion. At least one tray is removably mounted to the body of the center console. The bin has a first position where the mounting portion is located in the interior compartment of the center console and the bin compartment is accessible from outside the center console. The bin has a second position where the mounting portion is removed from the interior compartment and the at least one tray is connectable to the mounting portion to define a support surface.

According to another aspect, a modular tray console for a vehicle comprises a center console including a body defining an interior compartment, and a bin removably received in the interior compartment. The bin defines a bin compartment and has a mounting portion. A first tray is removably mounted to the body of the center console. A separate second tray is removably mounted to the body of the center console. The bin has a first position where the mounting portion is located in the interior compartment of the center console and the bin compartment is accessible from outside the center console. The bin has a second position where the mounting portion is removed from the interior compartment and each of the first tray and the second tray is connectable to the mounting portion to define a respective first support surface and a second support surface. The mounting portion of the bin is configured to allow for an adjustable height of each of the first tray and the second tray relative to one of the center console and an associated subjacent surface.

According to another aspect, a vehicle comprises a front seat, a rear seat, and a center console. The center console includes a body defining an interior compartment. The center console is movable between a forward location for use with the front seat and a rearward location for use with the rear seat. A bin is removably received in the interior compartment. The bin defines a bin compartment and has a mounting portion. At least one tray is removably mounted to the body of the center console. The bin has a first position where the mounting portion is located in the interior compartment of the center console and the bin compartment is accessible from outside the center console. The bin has a second position where the mounting portion is removed from the interior compartment. With the center console in the rearward location and the bin in the second position, the at least one tray is connectable to the mounting portion to define a support surface.

### BRIEF DESCRIPTION OF THE DRAWINGS

FIG. 1 is a perspective view of a modular tray console including a center console, a bin, trays and a basket.

FIG. 2 is a perspective view of the modular tray console without the basket.

FIGS. 3 and 4 are perspective views of FIG. 2 with the bin and trays removed.

FIG. 5 is a top view of FIG. 2.

FIG. 6 is a perspective view of the bin in a first position, the bin having a body and a mounting portion.

FIG. 7 is a perspective view of the bin in a second position.

FIGS. 8 and 9 are perspective views of dial rods for use with the mounting portion of the bin.

FIG. 10 is a top view of one of the trays.

FIG. 11 is a perspective view of the modular tray console with the trays connected to the mounting portion of the bin, the trays are horizontally aligned.

FIG. 12 is a perspective view of FIG. 11.

FIG. 13 is a perspective view of the modular tray console with two of the trays connected to the mounting portion of the bin, the trays are offset in a height direction.

FIG. 14 depicts an exemplary method of assembling the modular tray console.

FIG. 15 illustrates use of the modular tray console within a vehicle.

FIG. 16 is a perspective view of a table configuration using the bin, the trays and support legs.

FIG. 17 depicts an exemplary method of forming the table configuration of FIG. 16.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or feature's relationship to another element(s) and/or feature(s) as, for example, illustrated in the figures. Further, any term of degree used herein, such as "substantially", means a reasonable amount of deviation of the modified word is contemplated such that the end result is not significantly changed. For example, such terms can be construed as allowing a deviation of at least 5% of the modified word if this deviation would not negate the meaning of the word the term of degree modifies.

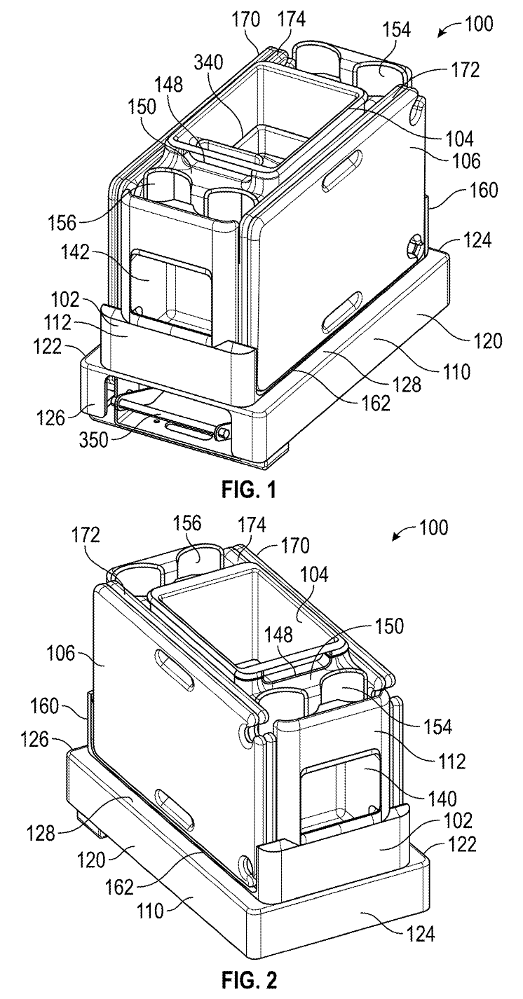

Referring now to the drawings, wherein like numerals refer to like parts throughout the several views, FIGS. 1-5 illustrate a modular tray console 100 for a vehicle according to the present disclosure. The modular tray console 100 generally comprises a center console 102, a bin 104, and at least one tray 106 removably connected to the center console. The center console includes a base 110 and a body 112 supported on the base. The base 110 includes a first side 120, a second side 122 spaced from the first side in a width direction of the base, a first or forward end wall 124, and a second or rear end wall 126 spaced from the first end in a length direction of the base. The base 110 further includes an upper surface 128. The body 112 includes a first side wall 130, a second side wall 132 spaced from the first sidewall in a width direction of the center console, a first or forward end 134, and a second or rear end 136 spaced from the first end in a length direction of the center console. The forward end 134 of the body 112 can include a forward storage compartment 140, and the rear end 136 of the body can include a rear storage compartment 142. The body 112 defines an interior compartment 148 with an open end provided on an upper wall 150. The upper wall 150 can be provided with at least one forward container holder 154 and at least one rear container holder 156.

The at least one tray 106 is secured by the one of the side walls of the body, for example, the first side wall 130 of the body 112. The at least one tray 106 is separate from the body 112 and is completely removable from the body 112. In the depicted aspect, the first side wall 130 includes a receiving structure or sleeve 160 configured to at least partially receive and store the at least one tray. The receiving structure 160 can be formed by extensions of the forward end 134 and the rear end 136 of the body 112 and a flange 162 provided on the upper surface 128 of the base 110 and interconnecting the forward and rear ends 134, 136. The receiving structure 160 defines at least one slot 166 for sliding receipt of the at least one tray 106. A locking feature (not shown) can be provided on the body 112 for maintaining the at least one tray 106 within the receiving structure 160. According to the present disclosure, the at least one tray 106 is a first tray 106, and the modular tray console 100 further includes a separate second tray 170 secured by a similarly structured receiving structure or sleeve provided on the second side wall 132 for receiving and storing the second tray 170. The modular tray console 100 can further include a separate third tray 172 and a separate fourth tray 174. The third tray 172 can be stored adjacent the first tray 106 in the receiving structure 160 provided on the first side wall 130, and the fourth tray 174 can be stored adjacent the second tray 170 in the receiving structure provided on the second side wall 132. With the use of the receiving structures, the trays 106, 170, 172, 174 can be easily stored on the center console 102 and selectively removed from the center console.

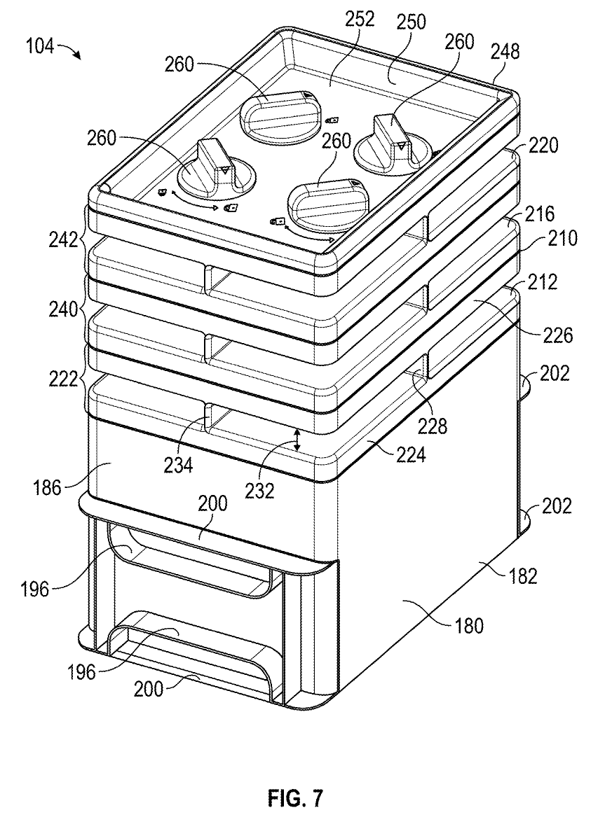

The bin 104 is removably received in the interior compartment 148 of the body 112 of the center console 102. With reference to FIGS. 6 and 7, the bin 104 includes a body 180 having a first side 182, a second side 184 spaced from the first side in a width direction of the body 180, a first end 186, and a second end 188 spaced from the first end in a length direction of the body 180. The body 180 defines a bin compartment 190 having an open top and a bottom wall 194. As depicted, the first end 186 can include at least one first handle 196, and the second end 188 can include at least one second handle 198. At least one first flange 200 extends from the first end 186 of the body 180 and forms part of the at least one first handle 196, and at least one second flange 202 extends from the second end 188 of the body and forms part of the at least one second handle 198. The handles allow for ease of handling the bin 104, including the removal of the bin from the interior compartment 148.

The bin 104 further includes a mounting portion 210 vertically aligned with the body 180. The mounting portion 210 includes at least one mounting platform defining at least one mounting location for selectively receiving at least one of the trays. According to one aspect, the mounting portion 210 includes three vertically spaced mounting platforms, specifically, a first mounting platform 212 defining a first mounting location, a second mounting platform 216 defining a second mounting location, and a third mounting platform 220 defining a third mounting location. The first mounting platform 212 is provided immediately adjacent the bottom wall 194 of the body 180, and the second mounting platform 216 is between the first and third mounting platforms. It should be appreciated that more or less than the depicted three mounting platforms for the mounting portion 210 of the bin 104 are contemplated.

Each mounting platform can be part of a separate mounting module. For example, the first mounting platform 212 can be part of a first mounting module 222 having a first wall 224, a second wall 226 vertically spaced from the first wall, and at least one support rib 228 interconnecting the first and second walls. An upper exterior surface of the first wall defines the first platform 212. A vertical spacing 232 between the first and second walls 224, 226 is sized to receive one of the trays (i.e., the spacing is slightly greater than a width dimension of each tray), with the at least one support rib 228 serving as a guide for the trays on the first mounting module 222. As depicted, the at least one support rib 228 is a first support rib 228, and the first mounting module 222 can include a second support rib 234 that intersects the first support rib 228 thereby separating the first platform 212 into quadrants, one for each tray. The second mounting platform 216 can be part of a second mounting module 240, and the third mounting platform 220 can be part of a third mounting module 242. Each of the second mounting module 240 and the third mounting module 242 can be constructed similar to the first mounting module 222. Further, the mounting modules 222, 240, 242 can be separate and distinct from one another, and interconnected via fasteners; although, this is not required.

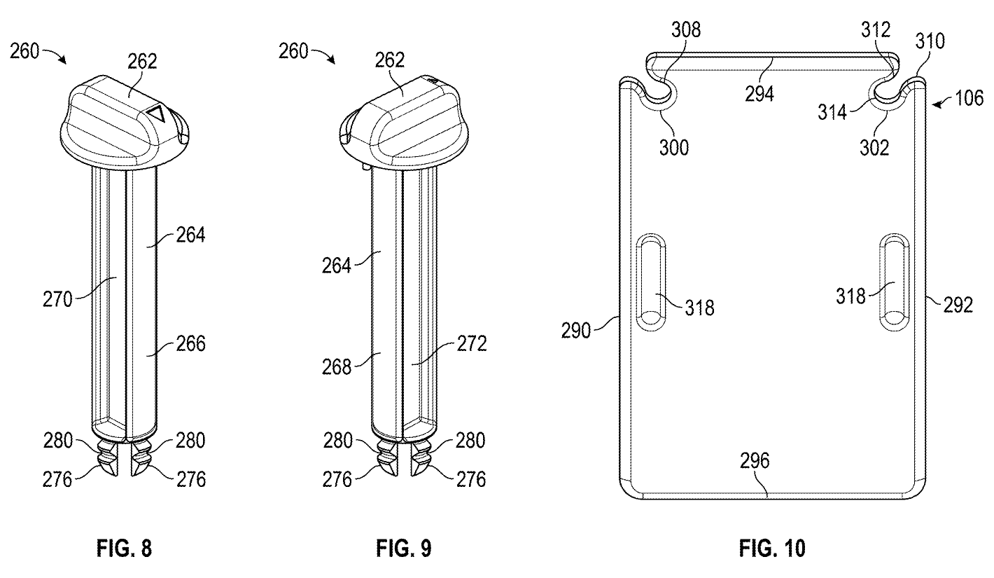

The mounting portion 210 further includes a top plate 248 secured to the uppermost mounting module, i.e., the third mounting module 242. The top plate 248 includes a side wall 250 and a base wall 252. Dial rods 260 for connecting each of the trays to the mounting portion 210 extend through the base wall 252 of the top plate 248 and each of the mounting modules 222, 240, 242. In FIGS. 8 and 9, each dial rod 260 includes a head 262 configured for gripping by a user and a shaft 264 extended from the head. The shaft 264 includes engaging surfaces 266, 268, which in the depicted aspect are separated by channels 270, 272. Mounting tabs 276 with grooves 280 extend from the bottom of the shaft 264. In FIG. 6, the mounting tabs are received in openings 282 in the bottom wall 194 of the bin compartment 190 with inner surfaces of the bottom wall 194 defining the openings 282 received in the grooves 280.

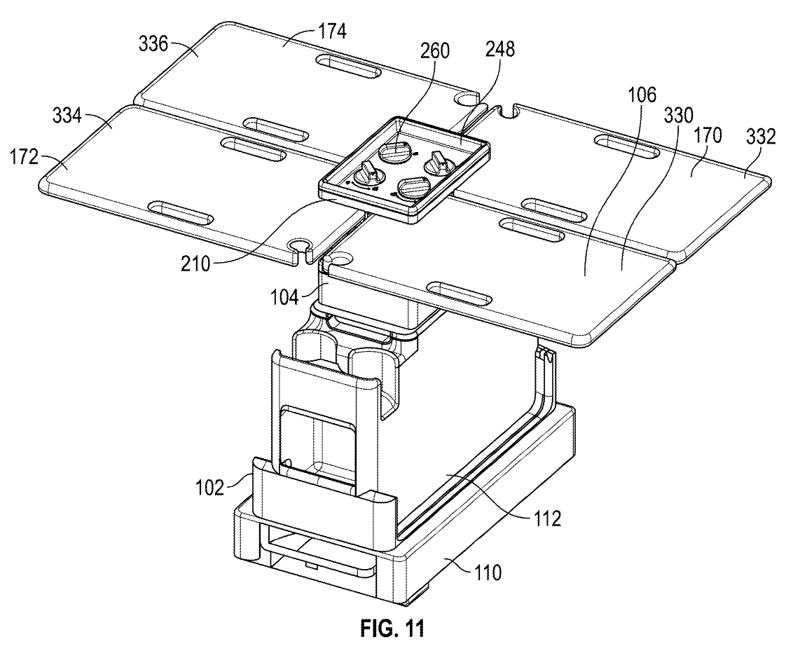

FIG. 10 shows various features of the tray 106; and it should be appreciated that the trays 170, 172, 174 are similarly constructed. The tray 106 includes a first side 290, a second side 292 spaced from the first sidewall in a width direction of the tray, a first end 294, and a second end 296 spaced from the first end in a length direction of the tray. Each of a first corner portion 300 at an intersection of the first side 290 and the first end 294 and a second corner portion 302 at an intersection of the second side 292 and the first end 294 includes a slotted opening 308. Each slotted opening 308 has a flared open-end section 310, a reduced dimensioned neck section 312 and a circular section 314. Further depicted are handles 318, and additional features like a cup holder can be provided on the tray. It should be appreciated that when securing the tray 106 to the mounting portion 210 of the bin 104, one of the slotted openings 308 receives the shaft 264 of one dial rod 260. To secure the tray 106, the shaft 264 of the dial rod 260 is oriented so that one of the engaging surfaces 266, 268 of the shaft 264 is first inserted into the open-end section 310 and the channels 270, 272 of the shaft 264 will face the neck section 312 as the shaft is being slid through the slotted opening 308. Once in the circular section 314, the shaft 326 is rotated causing the engaging surfaces 266, 268 to frictionally engage the circular section 314, thereby securing the tray 106 to the mounting portion 210.

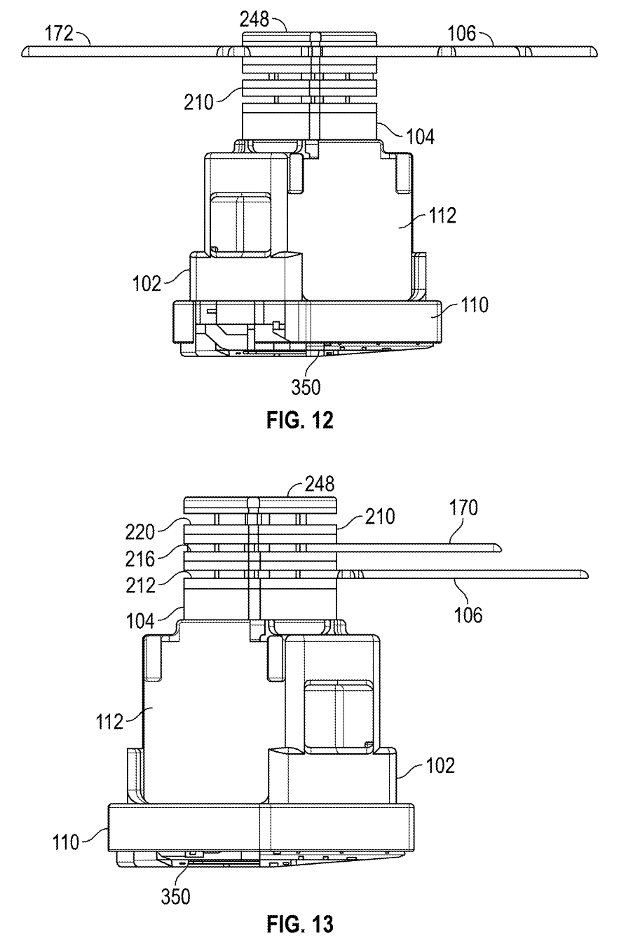

The bin 104 has a first position where the mounting portion 210 is located in the interior compartment 148 of the center console 102 and the bin compartment 190 is accessible from outside the center console (see FIG. 2). The bin 104 has a second position where the mounting portion 210 is removed from the interior compartment 148 and the at least one tray 106, 170, 172, 174 is connectable to the mounting portion 210 to define a support surface (FIGS. 11-13). The body 112 of the center console 102 is configured to support the bin 104 in the second position with the mounting portion extended above the center console. The bin 104 is upright in the first position and the bin is inverted in the second position. In FIG. 11, each of the first tray 106, the second tray 170, the third tray 172 and the fourth tray 174 is separately connectable to the mounting portion 210 of the bin 104 to define a respective first support surface 330, a second support surface 332, a third support surface 334, a fourth support surface 336. The mounting portion 210 of the bin 104 is configured to allow for an adjustable height of each tray 106, 170, 172, 174 relative to one of the center console 102 and an associated subjacent surface. By way of example, in FIGS. 11 and 12, when connected to the mounting portion 210 the trays 106, 170, 172, 174 are horizontally aligned. In FIG. 13, when connected to the mounting portion 210 the first tray 106 is offset in a height direction from the second tray 170, with the first tray 106 secured on the first mounting platform 212 and the second tray 170 secured on the second mounting platform 216. With the mounting portion 210, the trays can be arranged at different heights, either horizontally aligned with one of the other trays or offset in the height direction from one of the other trays.

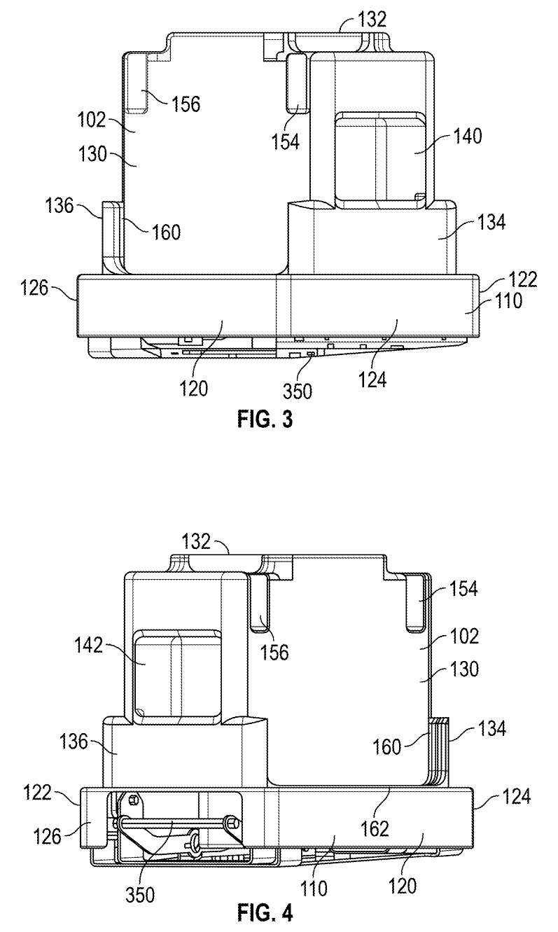

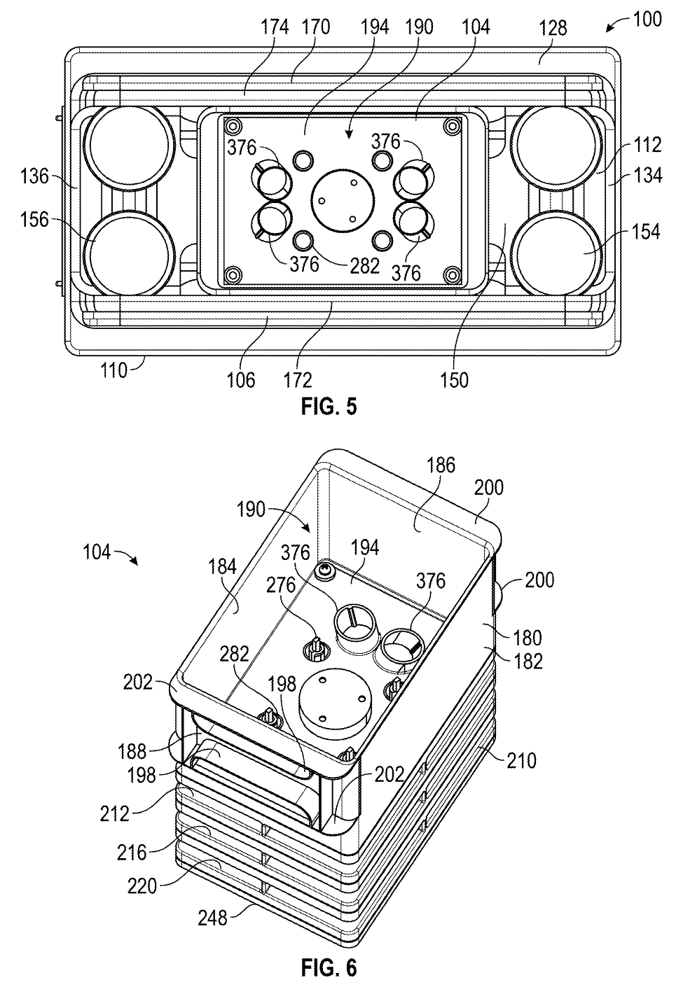

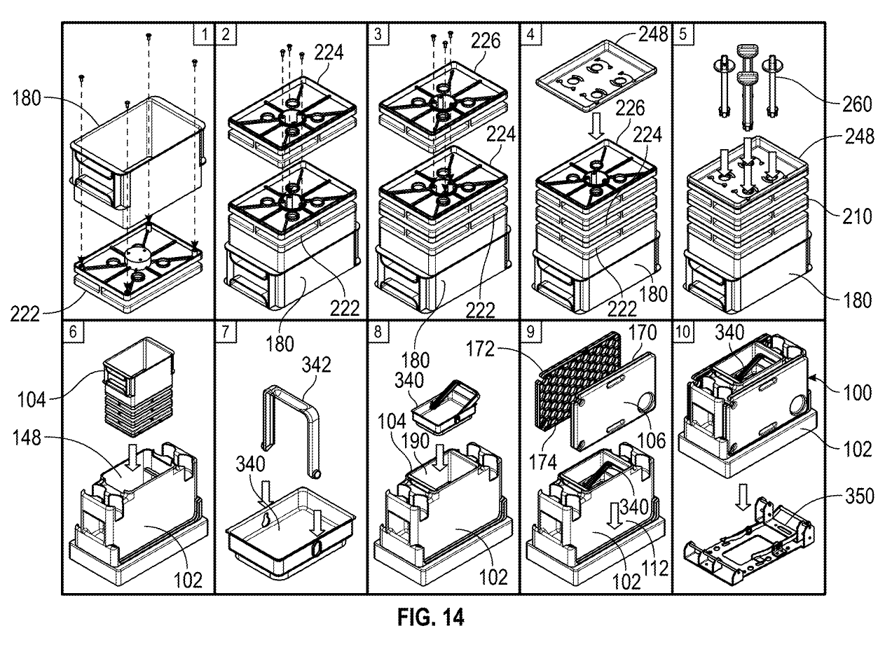

FIG. 14 depicts an exemplary method of assembling the modular tray console 100. In FIG. 14-1, the first mounting module 222 of the mounting portion 210 is fastened to the bottom wall 194 of the body 180. In FIG. 14-2, the second mounting module 240 is fastened to the first mounting module 222. In FIG. 14-3, the third mounting module 242 is fastened to the second mounting module 240. In FIG. 14-4, the top plate 248 is positioned on the third mounting module 242. In FIG. 14-5, the mounting portion 210 is assembled and the dial rods 260 are inserted through the mounting portion 210 to secure the together the mounting modules 222, 240, 242 and the top plate 248. In FIG. 14-6, the bin 104 is in the first position and is being inserted into the interior compartment 148 of the center console 102. In FIG. 14-7, a basket 340 is connected with a handle 342. In FIG. 14-8, the assembled basket 340 is placed at least partially in the bin compartment 190 of the bin 104 when in the first position within the interior compartment 148. In FIG. 14-9, the trays 106, 170, 172, 174 are placed in the receiving structures provided on the first side wall 130 and the second side wall 132 of the body 112 of the center console 102. In FIG. 14-10, the now assembled modular tray console 100 is seated on a frame 350. The frame 350 is connectable to rails provided in a vehicle, allowing the modular tray console 100 to move forward and rearward within the vehicle.

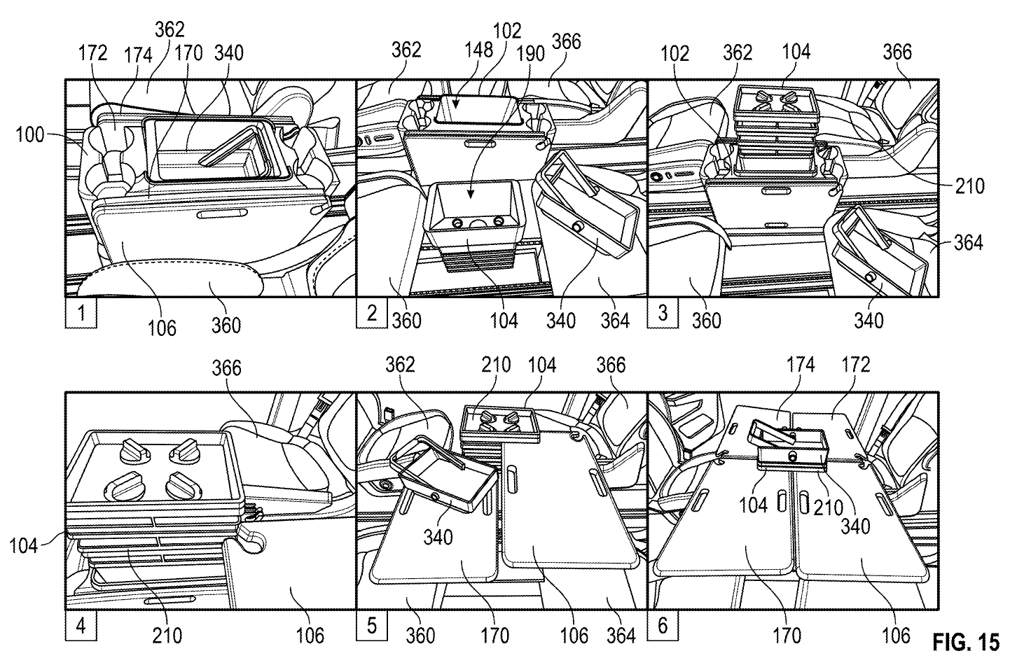

FIG. 15 illustrates use of the modular tray console 100 within a vehicle. In FIG. 15-1, the modular tray console 100 is located between front seats 360, 362. In FIG. 15-2, the modular tray console 100 is moved via the frame 350 and rails to a position forward of rear seats 364, 366. In certain vehicle models, the front seats can be rotated to face the rear seats; although, this is not required for use of the trays. The bin 104 is removed from the interior compartment 148 of the center console 102, and the basket 340 is removed from within the bin compartment 190. It should be appreciated that the center console 102 can include a lifting mechanism (e.g., a spring mechanism connected to the center console body that engages the bin) within the interior compartment 148 to assist in the removal of the bin 104. In FIG. 15-3, the bin 104 is inverted to the second position and is seated at least partially within the interior compartment 148 of the center console 102. In FIGS. 15-4 and 15-5, the first and second trays 106, 170 are being connected to the mounting portion 210 of the bin 104. In FIG. 15-6, each tray 106, 170, 172, 174 is connected to the mounting portion 210 of the bin 104, the trays being horizontally aligned. The basket 340 is supported by the top plate 248 of the mounting portion 210 of the bin 104 in the second position.

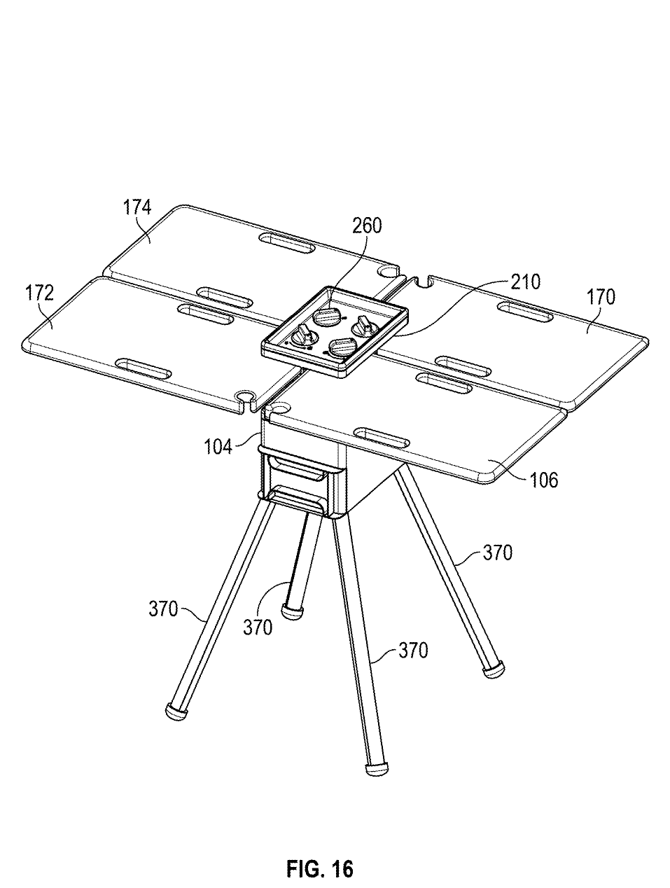

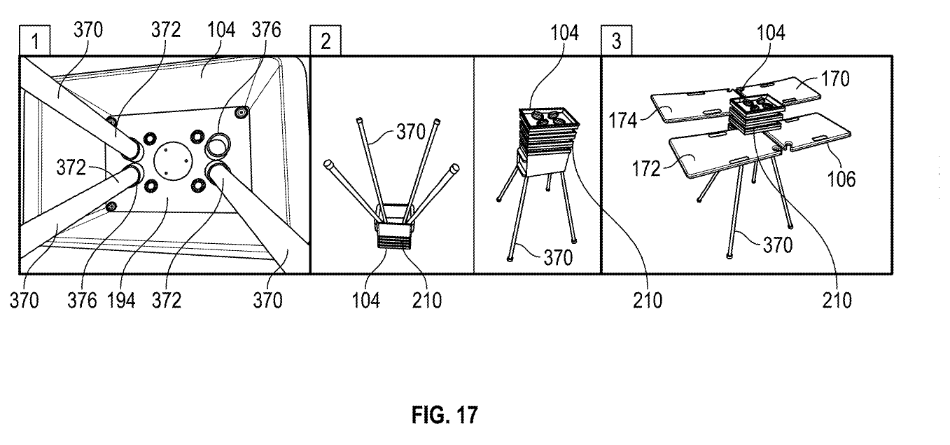

FIG. 16 is an example of the bin 104 and the trays 106, 170, 172, 174 used without the center console 102, outside a vehicle in a table configuration. Support legs 370 are releasably connected to the bin 104 in the second position and support the bin on an associated subjacent surface (e.g., a lawn or drive) in the second position. FIG. 17 depicts an exemplary method of forming the table configuration of FIG. 16. In FIG. 17-1, end portions 372 of the support legs 370 are received in sleeves 376 secured to the bottom wall 194 defining the bin compartment 190, thereby connecting the end portions to the bottom wall. In FIG. 17-2, the support legs are connected to the bin 104 in the first position, and then the bin is moved to the second position with the support legs 370 connected thereto. In FIG. 17-3, the trays 106, 170, 172, 174 are connected to the mounting portion 210 of the bin 104. As shown, the trays 106, 172 are horizontally aligned at a first height, and the trays 170, 174 are horizontally aligned at a second height; although, this is by way of example.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A modular tray console for a vehicle comprising:
a center console including a body defining an interior compartment;
a bin removably received in the interior compartment, the bin defining a bin compartment and having a mounting portion; and
at least one tray removably mounted to the body of the center console,
wherein the bin has a first position where the mounting portion is located in the interior compartment of the center console and the bin compartment is accessible from outside the center console, and a second position where the mounting portion is removed from the interior compartment and the at least one tray is connectable to the mounting portion to define a support surface.

2. The modular tray console of claim 1, wherein the bin is upright in the first position and the bin is inverted in the second position.

3. The modular tray console of claim 1, including a basket removably supported by the bin in both the first position and the second position.

4. The modular tray console of claim 1, wherein the body of the center console is configured to support the bin in the second position with the mounting portion extended above the center console.

5. The modular tray console of claim 1, including support legs releasably connected to the bin in the second position, the support legs supporting the bin in the second position.

6. The modular tray console of claim 5, wherein end portions of the support legs are received in the bin compartment and are connected to a bottom wall of the bin compartment.

7. The modular tray console of claim 1, wherein the body of the center console includes a first sidewall and a second sidewall spaced from the first sidewall in a width direction of the center console, the at least one tray is secured by the first sidewall.

8. The modular tray console of claim 7, wherein the first sidewall includes a slot configured to at least partially receive the at least one tray.

9. The modular tray console of claim 7, wherein the at least one tray includes a first tray and a separate second tray, the first tray secured by the first sidewall, and the second tray secured by the second sidewall, each of the first tray and the second tray being separately connectable to the mounting portion of the bin to define a respective first support surface and a second support surface.

10. The modular tray console of claim 9, wherein the mounting portion of the bin is configured to allow for an adjustable height of each of the first tray and the second tray relative to one of the center console and an associated subjacent surface.

11. The modular tray console of claim 10, wherein when connected to the mounting portion the first tray and the second tray are horizontally aligned.

12. The modular tray console of claim 10, wherein when connected to the mounting portion the first tray is offset in a height direction from the second tray.

13. A modular tray console for a vehicle comprising:
a center console including a body defining an interior compartment;
a bin removably received in the interior compartment, the bin defining a bin compartment and having a mounting portion; and
a first tray removably mounted to the body of the center console;
a separate second tray removably mounted to the body of the center console,
wherein the bin has a first position where the mounting portion is located in the interior compartment of the center console and the bin compartment is accessible from outside the center console, and a second position where the mounting portion is removed from the interior compartment and each of the first tray and the second tray is connectable to the mounting portion to define a respective first support surface and a second support surface,
wherein the mounting portion of the bin is configured to allow for an adjustable height of each of the first tray and the second tray relative to one of the center console and an associated subjacent surface.

14. The modular tray console of claim 13, including a basket removably supported by the bin in both the first position and the second position.

15. The modular tray console of claim 13, including support legs releasably connected to the bin in the second position, the support legs supporting the bin in the second position.

16. The modular tray console of claim 13, wherein the body of the console includes a first sidewall and a second sidewall spaced from the first sidewall in a width direction of the center console, the first tray is secured by the first sidewall and the second tray is secured by the second sidewall.

17. The modular tray console of claim 16, including a separate third tray and a separate fourth tray, each of the third tray and the fourth tray is connectable to the mounting portion to define a respective third support surface and a fourth support surface, and the mounting portion of the bin is configured to allow for an adjustable height of each of the third tray and the fourth tray, wherein the third tray is secured by the first sidewall and the fourth tray is secured by the second sidewall.

18. A vehicle comprising:
a front seat and a rear seat;
a center console including a body defining an interior compartment, the center console movable between a forward location for use with the front seat and a rearward location for use with the rear seat;
a bin removably received in the interior compartment, the bin defining a bin compartment and having a mounting portion; and
at least one tray removably mounted to the body of the center console,
wherein the bin has a first position where the mounting portion is located in the interior compartment of the center console and the bin compartment is accessible from outside the center console, and a second position where the mounting portion is removed from the interior compartment,
wherein with the center console in the rearward location and the bin in the second position, the at least one tray is connectable to the mounting portion to define a support surface.

19. The vehicle of claim 18, wherein the body of the console includes a first sidewall and a second sidewall spaced from the first sidewall in a width direction of the center console,
wherein the at least one tray includes a first tray and a separate second tray, the first secured by the first sidewall, and the second tray secured by the second sidewall, each of the first tray and the second tray being separately connectable to the mounting portion of the bin to define a respective first support surface and a second support surface.

20. The vehicle of claim 19, wherein the mounting portion of the bin is configured to allow for an adjustable height of each of the first tray and the second tray relative to the center console.
